(19) United States
(12) Patent Application Publication
(10) Pub. No.: US 2026/0121150 A1
(43) Pub. Date: Apr. 30, 2026

(54) ENERGY STORAGE SYSTEM COLD START POWER DISCHARGE ENHANCEMENT USING MULTIPLE BRANCH COOLANT SYSTEM

(71) Applicant: GM GLOBAL TECHNOLOGY OPERATIONS LLC, Detroit, MI (US)

(72) Inventors: Justin A. Bunnell, Cary, NC (US); Philip J. Prociw, Clinton Township, MI (US); Andres V. Mituta, Lake Orion, MI (US); Benjamin C. Groen, Troy, MI (US); Jeffrey A. Bednar, South Lyon, MI (US)

(73) Assignee: GM GLOBAL TECHNOLOGY OPERATIONS LLC, Detroit, MI (US)

(21) Appl. No.: 18/930,791

(22) Filed: Oct. 29, 2024

(51) Int. Cl. H01M 10/633; B60K 11/02; B60L 50/64; B60L 58/12; B60L 58/26; H01M 10/48; H01M 10/613; H01M 10/615; H01M 10/625; H01M 10/635; H01M 10/656; H01M 50/258; H01M 50/512; H02J 7/00

(52) U.S. Cl. CPC H01M 10/633; B60K 11/02; B60L 50/64; B60L 58/12; B60L 58/26; H01M 10/482; H01M 10/486; H01M 10/613; H01M 10/615; H01M 10/625; H01M 10/635; H01M 10/656; H01M 50/258; H01M 50/512; H02J 7/82; H01M 2220/20

(57) ABSTRACT

A system for enhancing cold start discharge power of a multi-cell rechargeable energy storage system (RESS) having battery cells connected in electrically parallel battery modules includes a cooling subsystem. The subsystem has a main coolant loop circulating coolant, multiple coolant branches arranged in parallel, and flow-valve(s) regulating and distributing coolant from the main loop across the branches. At least some coolant branches receive portions of the coolant from the main loop to adjust temperature of corresponding individual battery modules. An electronic controller detects when RESS temperature is at or below a predetermined value and increases temperature of coolant in the main coolant loop above the predetermined value via a heater. The controller also selects battery module(s) and identifies coolant branch(s) associated therewith. The controller further shuts off coolant flow into coolant branches of non-selected battery module(s) to exclusively heat selected battery module(s) and enhance RESS cold start discharge power.

### INTRODUCTION

The present disclosure relates to cold start power discharge enhancement in a multi-cell rechargeable energy storage system (RESS) using a multiple branch coolant system.

Typically, an electric energy generation and storage battery system includes one or more battery cells for powering a load. A plurality of battery cells may be arranged in close proximity to one another to generate a battery module and a plurality of battery modules may be organized into a battery pack array. Batteries may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental, and ease-of-use benefits compared to disposable batteries.

Rechargeable batteries may be used to power such diverse items as toys, consumer electronics, and motor vehicles. Particular chemistries of rechargeable batteries, such as lithium-ion cells, as well as external factors, may cause internal reaction rates generating significant amounts of thermal energy. Exposure of a battery cell to elevated temperatures over prolonged periods may cause the cell to experience a thermal runaway event, where heat build-up in an individual cell leads to the heat spreading to adjacent cells in the module and affecting the entire battery array. Additionally, temperature extremes may affect battery cell power generation. Accordingly, thermal energy needs to be effectively managed to optimize battery system performance. Generally, devices such as heat-sinks or cold-plates with circulating coolant are employed to remove heat from battery systems.

### SUMMARY

A system for enhancing cold start discharge power of a multi-cell rechargeable energy storage system (RESS) having a plurality of battery cells arranged in individual battery modules connected electrically in parallel includes a cooling subsystem. The cooling subsystem has a main coolant loop circulating coolant, a coolant heater arranged in the main coolant loop, and a plurality of coolant branches arranged in parallel. At least some of the coolant branches are configured to receive respective portions of the coolant from the main coolant loop to adjust the temperature of corresponding individual battery modules. The cooling subsystem also has flow-valve(s) for regulating and distributing the coolant from the main coolant loop across the coolant branches. The system also includes an electronic controller in operative communication with the cooling subsystem.

The electronic controller is configured to detect the temperature of the RESS being at or below a predetermined value. The electronic controller is also configured to increase temperature of the coolant, using the coolant heater, in the main coolant loop above the predetermined value and select at least one battery module, but fewer than all the respective battery modules, in the RESS using predetermined criteria. The electronic controller is additionally configured to identify each coolant branch, from among the plurality of coolant branches, associated with the selected battery module(s). The electronic controller is further configured to shut off, via the flow-valve(s), a flow of the coolant into coolant branches not associated with the selected battery module(s). Such action is intended to exclusively, i.e., to the exclusion of at least the non-selected battery modules, heat the selected battery module(s) via the increased temperature coolant and thereby enhance cold start discharge power of the RESS.

The at least one selected battery module may be a single battery module.

The predetermined criteria may include whether cold start discharge power capability of the RESS is determined or projected to be greater with heating the at least one battery module as compared to heating each of the respective battery modules.

The predetermined criteria may include battery module state of charge (SOC) and battery module temperature, each associated with discharge power capability of the RESS. In such an embodiment, the subject predetermined criteria may be assembled into a look-up table, programmed into the electronic controller, including the battery module SOC and temperature versus the discharge power capability of the RESS over time.

The predetermined criteria may include whether cold start discharge power capability of the RESS is below a power threshold.

Following the shut off of the flow of the coolant into coolant branches not associated with the selected at least one battery module, the electronic controller may be additionally configured to assess whether discharge power of the RESS is at or above the power threshold. The electronic controller may be additionally configured to open, via the at least one flow-valve, flow of the coolant into each of the coolant branches arranged in parallel when the discharge power is at or above the power threshold to equalize temperatures throughout the RESS battery modules.

Each battery module may include a respective temperature sensor in communication with the electronic controller and configured to detect a temperature of the corresponding battery module. In such an embodiment, the electronic controller may be additionally configured to determine, using the temperature sensors, when the temperatures throughout the RESS battery modules have been equalized.

The flow-valve may be a multi-way valve assembly arranged in a junction between the main coolant loop and the plurality of coolant branches. Such a multi-way valve may be configured to control the flow of the coolant into each of the coolant branches.

Alternatively, a plurality of throttle valves may regulate the flow of the coolant from the main coolant loop. Each throttle valve may be arranged in one of the coolant branches upstream of the corresponding battery module and be configured to control the flow of the coolant into the subject coolant branch.

Each coolant branch may include a one-way valve configured to control the flow of the coolant out of the subject coolant branch.

The cooling subsystem may also include a fluid pump configured to circulate the coolant through the main coolant loop.

A motor vehicle employing a system for enhancing cold start discharge power of a RESS, as described above, and a method of enhancing cold start discharge power of a RESS are also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of an embodiment of a motor vehicle employing multiple power-sources, a multi-cell rechargeable energy storage system (RESS) configured to generate and store electrical energy used by vehicle systems, and a system for enhancing RESS cold start discharge power, according to the disclosure.

FIG. 2 is a schematic illustration of the system for enhancing RESS cold start discharge power shown in FIG. 1, including an embodiment of a cooling subsystem having a main coolant loop and multiple parallel coolant branches subsystem for adjusting temperature in individual battery modules, according to the disclosure.

FIG. 3 is a schematic illustration of the system for enhancing RESS cold start discharge power shown in FIG. 1, including another embodiment of the cooling subsystem having a main coolant loop and multiple parallel coolant branches subsystem for adjusting temperature in individual battery modules, according to the disclosure.

FIG. 4 illustrates a method of enhancing cold start discharge power in a multi-cell RESS employing the coolant subsystem shown in FIGS. 1-3.

### DETAILED DESCRIPTION

Embodiments of the present disclosure as described herein are intended to serve as examples. Other embodiments may take various and alternative forms. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

Certain terminology may be used in the following description for the purpose of reference only, and thus are not intended to be limiting. For example, terms such as “above” and “below” refer to directions in the drawings to which reference is made. Terms such as “front”, “back”, “fore”, “aft”, “left”, “right”, “rear”, “side”, “upward”, “downward”, “top”, and “bottom”, etc., describe the orientation and/or location of portions of the components or elements within a consistent but arbitrary frame of reference, which is made clear by reference to the text and the associated drawings describing the components or elements under discussion.

Furthermore, terms such as “first”, “second”, “third”, and so on may be used to describe separate components. Such terminology may include the words specifically mentioned above, derivatives thereof, and words of similar import, and are used descriptively for the figures, and do not represent limitations on the scope of the disclosure, as defined by the appended claims. Moreover, the teachings may be described herein in terms of functional and/or logical block components and/or various processing steps. It should be realized that such block components may include a number of hardware, software, and/or firmware components configured to perform the specified functions.

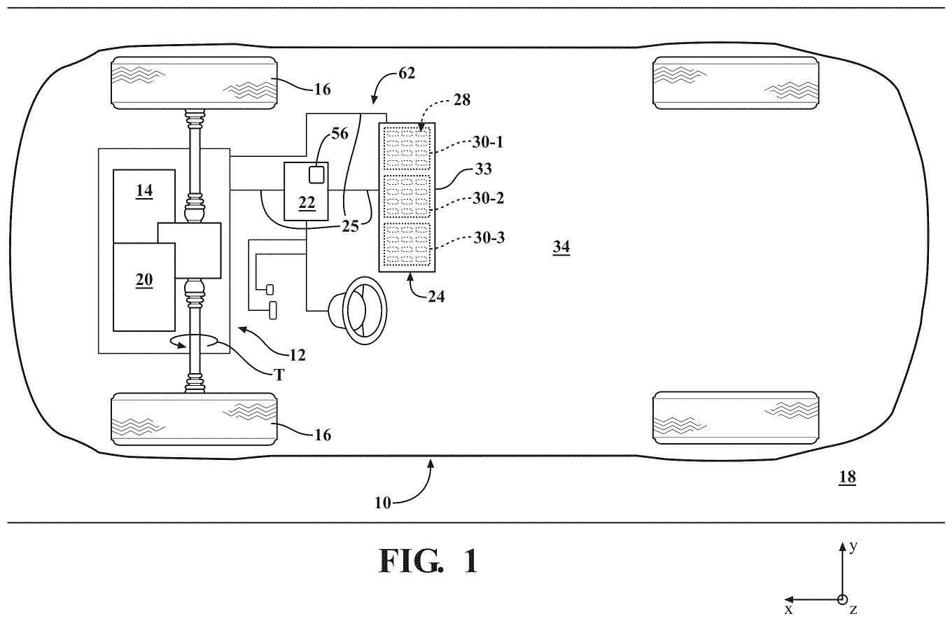

Referring to the drawings, wherein like reference numbers refer to like components, FIG. 1 shows a schematic view of a motor vehicle 10 having a powertrain 12. The vehicle 10 may include, but not be limited to, a commercial vehicle, industrial vehicle, passenger vehicle, aircraft, watercraft, train or the like. It is also contemplated that the vehicle 10 may be a mobile platform, such as an airplane, all-terrain vehicle (ATV), boat, personal movement apparatus, robot and the like to accomplish the purposes of this disclosure. The powertrain 12 includes a power-source 14 configured to generate a power-source torque T (shown in FIG. 1) for propulsion of the vehicle 10 via driven wheels 16 relative to a road surface 18. The power-source 14 is depicted as an electric motor-generator.

As shown in FIG. 1, the powertrain 12 may include an additional power-source 20, such as an internal combustion engine. The power-sources 14 and 20 may act in concert to power the vehicle 10. The vehicle 10 additionally includes a central processing unit (CPU) 22 and a multi-cell rechargeable energy storage system (RESS) 24 configured to generate and store electrical energy through heat-producing electro-chemical reactions for supplying the electrical energy to the power-sources 14 and 20. The CPU 22 regulates various systems of the vehicle 10, including the powertrain 12 to generate a predetermined amount of power-source torque T. The RESS 24 may be connected to the power-sources 14 and 20, to the electronic CPU 22, as well as to other vehicle systems via a high-voltage databus or BUS 25.

As shown in FIGS. 1-3, the RESS 24 includes a plurality of battery cells 28, such as lithium-ion rechargeable cells, arranged in individual battery modules, such as a first module 30-1, a second module 30-2, and a third module 30-3. It is particularly intended that the subject modules 30-1, 30-2, 30-3 be arranged electrically in parallel. Within individual modules, e.g., 30-1, 30-2, 30-3, distinct battery cells 28 may be connected electrically in series or in parallel and assembled into cell groups. Such cell groups are then electrically connected in series and assembled into individual modules. Although three individual battery modules are specifically shown, it is intended that the RESS 24 includes at least two respective modules, and multiple modules may be organized into battery packs.

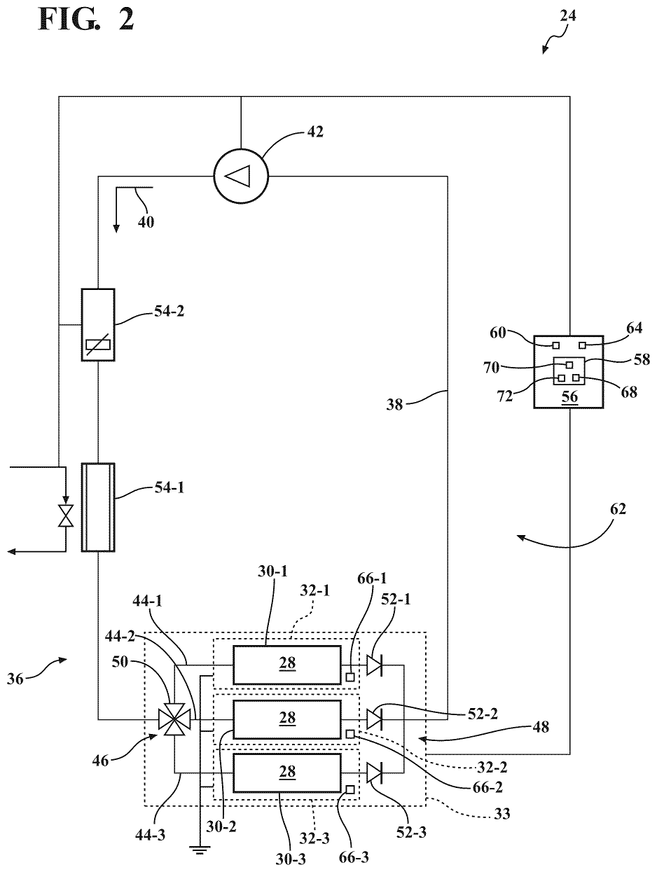

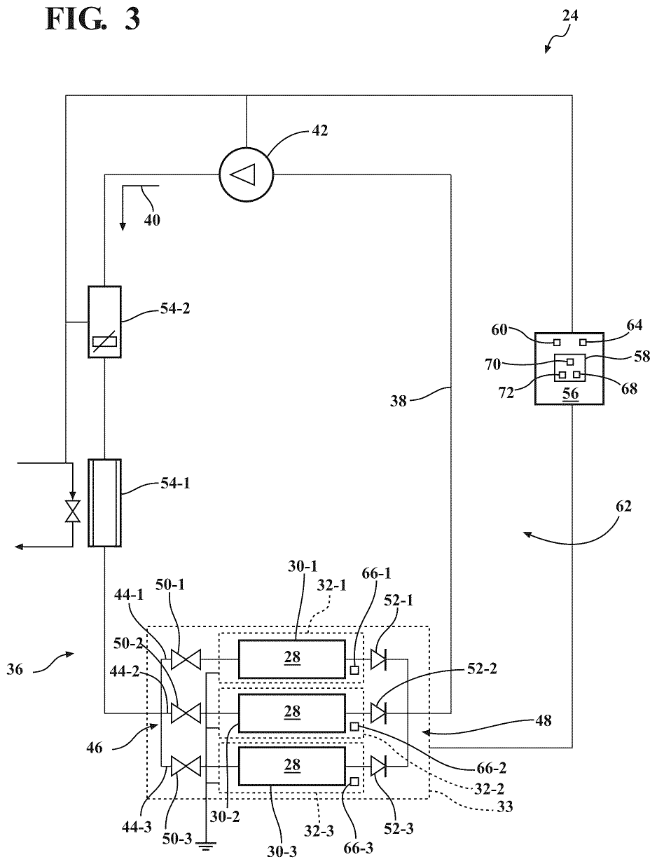

The remainder of the present description will focus on RESS 24 construction having three battery modules 30-1, 30-2, 30-3, with each battery module having a desired quantity of battery cells 28. As shown in FIGS. 2 and 3, each battery module 30-1, 30-2, 30-3 includes a respective battery module enclosure 32-1, 32-2, 32-3 connected to chassis ground and configured to house and support the corresponding battery cells 28. The RESS 24 may also include a battery pack enclosure 33 surrounded by an ambient environment 34 and configured to house and support the battery modules 30-1, 30-2, 30-3 (shown in FIG. 1).

As shown in FIGS. 2 and 3, RESS 24 also includes a cooling subsystem 36 configured to remove thermal energy from various temperature sensitive components of the RESS. Cooling subsystem 36 includes a main coolant loop 38 configured to circulate a coolant 40 through the RESS 24. As shown, cooling subsystem 36 further includes a fluid pump 42 configured to circulate coolant 40 through the main coolant loop 38. The cooling subsystem 36 also includes a plurality of coolant branches, shown as a first branch 44-1, a second branch 44-2, and a third branch 44-3, in fluid communication with the main coolant loop 38. Each of the coolant branches 44-1, 44-2, 44-3 extends through a respective battery module 30-1, 30-2, 30-3, proximate and along the constituent battery cells 28.

Furthermore, each coolant branch 44-1, 44-2, 44-3 is configured to receive a portion of the coolant 40 from the main coolant loop 38. The coolant branches 44-1, 44-2, 44-3 are arranged fluidly in parallel to receive respective portions of the coolant 40. The coolant branches 44-1, 44-2, 44-3 are thereby configured to independently circulate their respective portions of the coolant 40 and adjust the temperature of the corresponding battery modules 30-1, 30-2, 30-3 (by removing or adding thermal energy). Accordingly, each coolant branch 44-1, 44-2, 44-3 passes through one of the battery module enclosures 32-1, 32-2, 32-3. As shown, the main coolant loop 38 may be in fluid communication with additional parallel coolant branches, for example to circulate the coolant through various devices such as auxiliary power modules (APMs), a Battery Disconnect Unit (BDU) including various electrical switches and relays, electrical connectors, a DC/DC converter for supplying 12V/48V power to the vehicle, etc., each having a particular temperature requirement. Accordingly, at least some of the coolant branches are configured to receive respective portions of the coolant 40 from the main coolant loop 38 to adjust the temperature of corresponding individual battery modules 30-1, 30-2, 30-3.

With continued reference to FIGS. 2 and 3, the RESS 24 may also include an inlet manifold 46 configured to connect the main coolant loop 38 to the coolant branches 44-1, 44-2, 44-3 and an outlet manifold 48 configured to connect the coolant branches back to the main coolant loop. Accordingly, the inlet and outlet manifolds 46, 48 are together configured to maintain circulation of coolant 40 through the cooling subsystem 36. The cooling subsystem 36 additionally includes at least one flow-valve 50. The flow-valve(s) 50 are configured to regulate and distribute across the individual coolant branches 44-1, 44-2, 44-3, the coolant 40 circulated through and received from the main coolant loop 38. In other words, the flow-valve(s) 50 are specifically structured and operated to provide independent regulation of coolant flow into each individual coolant branch 44-1, 44-2, 44-3.

As shown in FIG. 2, the flow-valve 50 may be a multi-way valve assembly arranged in a junction, such as the inlet manifold 46, between the main coolant loop 38 and the plurality of coolant branches 44-1, 44-2, 44-3 upstream of each battery module 30-1, 30-2, 30-3. The multi-way valve assembly embodiment of the flow-valve 50 may be configured to control the flow of coolant 40 into each of the coolant branches 44-1, 44-2, 44-3. As shown in FIG. 3, the flow-valve(s) 50 may be a plurality of individual throttle valves 50-1, 50-2, 50-3. Each subject throttle valve 50-1, 50-2, 50-3 may be arranged in one of the plurality of coolant branches 44-1, 44-2, 44-3 upstream of the corresponding battery module 30-1, 30-2, 30-3 and configured to control the flow of the coolant 40 into the subject coolant branch.

As shown in FIGS. 2 and 3, each coolant branch 44-1, 44-2, 44-3 may include a respective one-way valve 52-1, 52-2, 52-3. The one-way valves 52-1, 52-2, 52-3 are configured to prevent backflow of the coolant 40 into the corresponding coolant branches 44-1, 44-2, 44-3. Each of the one-way valves 52-1, 52-2, 52-3 is arranged aft of the flow-valve(s) 50 and downstream of the corresponding battery module 30-1, 30-2, 30-3. Accordingly, each one-way valve 52-1, 52-2, 52-3 is configured to control the flow of the corresponding portion of the coolant 40 through and out of the subject coolant branch 44-1, 44-2, 44-3. Cooling subsystem 36 may also include a plurality of heat exchangers arranged in the main coolant loop 38 to alter the temperature of the coolant 40. For example, one embodiment of such a heat exchanger may be a coolant chiller 54-1, for example, using a refrigerant, to remove thermal energy from the coolant 40 in the main coolant loop 38. Another embodiment of such a heat exchanger may be a coolant heater 54-2, for example, using electrical resistance, to add thermal energy to the coolant 40.

As shown in FIGS. 1-3, the multi-cell RESS 24 may additionally include an electronic controller 56 that may be either electronically connected to or be part of the CPU 22. The electronic controller 56 is in operative communication with the cooling subsystem 36, i.e., configured or programmed to regulate operation of the cooling subsystem, and may be structured to manage operation of the RESS 24 as a whole. As shown, the electronic controller 56 is in operative communication with the fluid pump 42, the flow-valve(s) 50, the coolant chiller 54-1, and the coolant heater 54-2. To support requisite management of the RESS 24 and/or the cooling subsystem 36, the electronic controller 56 specifically includes a processor and tangible, non-transitory memory, which includes requisite instructions programmed therein. The controller's memory may be an appropriate recordable medium that participates in providing computer-readable data or process instructions. Such a recordable medium may take many forms, including but not limited to non-volatile media and volatile media.

Non-volatile media for electronic controller 56 may include, for example, optical or magnetic disks and other persistent memory. Volatile media may include, for example, dynamic random-access memory (DRAM), which may constitute a main memory. The instructions programmed into the controller 56 may be transmitted by one or more transmission medium, including coaxial cables, copper wire and fiber optics, including the wires that comprise a system bus coupled to a processor of a computer, or via a wireless connection. Memory of the electronic controller 56 may also include a flexible disk, hard disk, magnetic tape, another magnetic medium, a CD-ROM, DVD, another optical medium, etc. The electronic controller 56 may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry.

The electronic controller 56 may be configured to regulate the flow of coolant 40 into the individual battery modules 30-1, 30-2, 30-3 through the corresponding coolant branches 44-1, 44-2, 44-3 via the fluid pump 42 and the flow-valve(s) 50. Algorithm(s), indicated generally via numeral 58, required by the electronic controller 56 or accessible thereby may be stored in the memory of the controller and automatically executed to facilitate operation of the RESS 24 and/or the cooling subsystem 36. Function of the cooling subsystem 36 may be regulated by the electronic controller 56 under normal operating conditions as well as for the purpose of enhancing RESS 24 performance during particular circumstances or transient conditions envisioned herein and described in detail below.

Generally, during regular operation of the RESS, coolant flow through the coolant branches 44-1, 44-2, 44-3 is used to absorb thermal energy released by battery cells 28 in the individual battery modules 30-1, 30-2, 30-3 and stabilize RESS operation. During steady operating conditions, the RESS has sufficient capacity to provide predictable power output to operate vehicle systems, including the powertrain 12. During vehicle 10 and RESS 24 cold start, however, the discharge power of the RESS may be limited due to battery cell temperature being below a particular temperature threshold 60 influenced by specific battery cell chemistry and the battery's state of charge (SOC). Under certain circumstances, higher power discharge rates may be achieved in a cold-soaked electrically parallel module RESS 24 by raising the temperature of at least one, but not all, of the battery modules 30-1, 30-2, 30-3. Such a result is attainable because, in a RESS having constituent modules connected electrically in parallel, each individual module is capable of supplying distinct electrical current and power.

As shown in FIG. 1, the vehicle 10 also includes a system 62 for enhancing or optimizing cold start discharge power generation of the RESS 24 and the electronic controller 56 is programmed with particular algorithm(s) 58 to operate the subject system. Specifically, the algorithm(s) 58 include an inventory mode configured to monitor ambient conditions and RESS 24 temperature prior to the vehicle 10 start-up to assess the likelihood of the RESS being requested to generate cold-start power while flow of coolant 40 is delivered to each of the coolant branches 44-1, 44-2, 44-3. The electronic controller 56 is also configured to detect a request 64 for the RESS 24 cold start discharge power, such as a key-on mode of the powertrain 12.

Prior to demanding the RESS 24 to discharge cold start power, the electronic controller 56 is additionally configured to detect a temperature of the RESS 24 being at or below a predetermined value such as the temperature threshold 60. Each battery module 30-1, 30-2, 30-3 may include a respective temperature sensor 66-1, 66-2, 66-3 in communication with the electronic controller 56 and configured to detect a temperature of the corresponding battery module. Signals from the temperature sensors 66-1, 66-2, 66-3 may be used to determine how the RESS 24 temperature compares to the temperature threshold 60. The electronic controller 56 is also configured to increase temperature of the coolant 40, using the coolant heater 54-2, in the main coolant loop 38 above the temperature threshold 60.

The electronic controller 56 is additionally configured to select at least one battery module, but fewer than all the respective battery modules, e.g., 30-1, 30-2, 30-3, in the RESS 24 using predetermined criteria 68, to be discussed in detail below. Specifically, the electronic controller 56 may select a single battery module, such as the module 30-1. The electronic controller 56 may then identify each coolant branch, from among the plurality of coolant branches, e.g., 44-1, 44-2, 44-3, associated with the selected battery module(s), such as the branch 44-1 corresponding to the module 30-1. The electronic controller 56 is further configured to shut off, via the flow-valve(s) 50, the flow of coolant 40 into coolant branches not associated with the selected battery module(s) or “non-associated branch(s)”, such as into branches 44-2, 44-3. Additionally, such non-associated coolant branches may include coolant branches dedicated to heating/cooling an APM, BDU, DC/DC converter, or other non-battery-module device in the RESS 24.

Such coolant shut-off is intended to particularly and exclusively (i.e., to the exclusion of at least the non-selected battery modules) heat the selected battery module(s), e.g., 30-1, via the increased temperature coolant 40 and thereby enhance cold start discharge power of the RESS 24. For example, the predetermined criteria 68 may include whether cold start discharge power capability of the RESS 24 is determined or projected to be greater with heating a particular battery module(s) in the RESS as compared to heating each of the respective battery modules 30-1, 30-2, 30-3. Alternatively, on cold start, system 62 may maintain the flow of coolant 40 into coolant branches associated with non-battery-module device(s) while shutting off coolant flow into coolant branch(s) of the non-selected battery module(s). Such action would permit the heating of selected battery module(s) in the RESS 24 while providing some coolant flow to other, non-battery-module devices.

The predetermined criteria 68 may include parameters such as battery module state of charge (SOC) and battery module temperature associated with discharge power capability of the RESS 24. The subject predetermined criteria 68 may be assembled into a look-up table 70, programmed into the electronic controller 56 and accessed by the algorithm(s) 58 during operation of system 62. The look-up table 70 includes the battery module SOC and temperature versus discharge power capability of the RESS over time, permitting the algorithm(s) 58 to select one or more battery module(s) to be heated in the RESS 24. The predetermined criteria 68 may also include whether cold start discharge power capability of the RESS 24 is below a power threshold 72. Such a power threshold may be indicative of a minimum power requirement for a cold start of the powertrain 12, as determined empirically for a particular vehicle 10, and programmed into the electronic controller 56.

After shutting off the coolant 40 flow into the non-associated coolant branch(s), e.g., 44-2, 44-3, the electronic controller 56 may demand cold start discharge power from the RESS 24, such as to operate the powertrain 12. Following the shut off of the coolant 40 flow into the non-associated branch(s) and triggered cold start power generation, the electronic controller 56 may be additionally configured to assess whether discharge power of the RESS 24 has risen to or above the power threshold 72. The electronic controller 56 may then open, via the flow-valve(s) 50, flow of the coolant 40 into each of the coolant branches arranged in parallel, including the coolant branch 44-1, 44-2, 44-3 associated with the respective battery modules, e.g., 30-1, 30-2, 30-3, in the RESS 24 when the discharge power has reached or exceeded the power threshold 72. The opening of each coolant branch would distribute available heated coolant 40 flow substantially equally across the constituent battery modules and other RESS devices and equalize temperatures throughout the RESS 24. The electronic controller 56 may then be additionally configured to determine, using the temperature sensors 66-1, 66-2, 66-3, when the temperatures throughout the battery modules of the RESS 24 have been equalized.

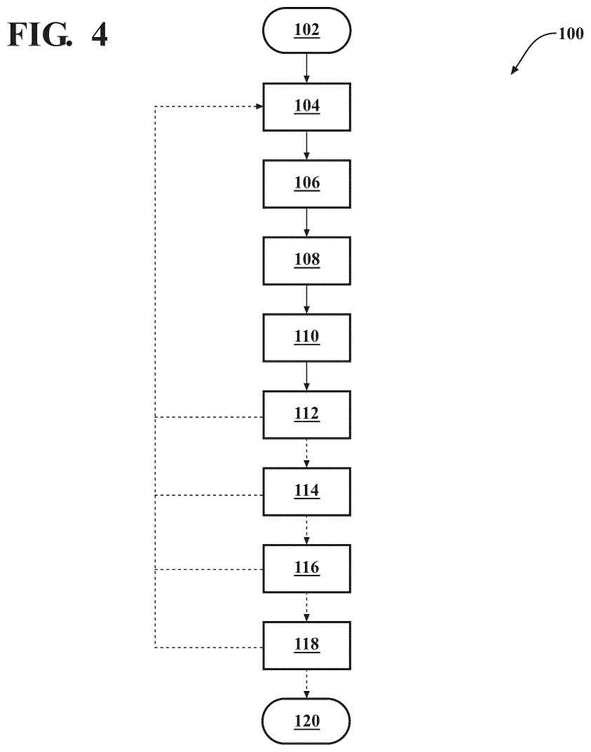

A method 100 of enhancing cold start discharge power in a multi-cell rechargeable energy storage system, such as the RESS 24, as shown in FIG. 4 and described below with reference to the structure shown in FIGS. 1-3. The method is specifically intended for use in the RESS employing a main coolant loop connected to a fluid pump, e.g., the main coolant loop 38, and a plurality of coolant branches, e.g., branches 44-1, 44-2, 44-3, arranged in parallel, each configured to receive a portion of the coolant 40 from the main coolant loop. The subject RESS also employs at least one flow-valve 50 configured to regulate and distribute the coolant 40 received from main coolant loop 38 across the plurality of coolant branches 44-1, 44-2, 44-3.

Method 100 commences in frame 102 with detecting, via the electronic controller 56, the request 64, e.g., key-on mode of the powertrain 12, for the RESS 24 cold start discharge power. After frame 102, the method proceeds to frame 104. In frame 104, prior to demanding generation of cold start discharge power from the RESS 24, the method includes detecting, via the electronic controller 56, temperature of the RESS being at or below the temperature threshold 60. Following frame 104, the method advances to frame 106. In frame 106, the method includes increasing, via the electronic controller 56, temperature of the coolant 40, using the coolant heater 54-2, in the main coolant loop 38 above the temperature threshold 60. Following completion of frame 106, the method moves on to frame 108.

In frame 108, the method includes selecting, via the electronic controller 56 at least one battery module, e.g., from the modules 30-1, 30-2, 30-3, but fewer than all the respective battery modules, in the RESS 24 using the predetermined criteria 68. As described above with respect to FIGS. 1-3, the predetermined criteria 68 may include battery module state of charge (SOC) and battery module temperature associated with discharge power capability of the RESS 24. The look-up table 70 may be assembled using such predetermined criteria 68 and programmed into the electronic controller 56 for access thereby during operation of system 62. The look-up table 70 includes the battery module SOC and temperature versus discharge power capability of the RESS over time, permitting the algorithm(s) 58 to select the battery module(s) to be heated. The predetermined criteria 68 may also include whether cold start discharge power capability of the RESS 24 is below the power threshold 72. After frame 108, the method proceeds to frame 110.

In frame 110, the method includes identifying, via the electronic controller 56, each coolant branch, from among the coolant branches 44-1, 44-2, 44-3, associated with the selected battery module(s). After frame 110, the method proceeds to frame 112. In frame 112, the method includes shutting off, via the electronic controller 56 using the flow-valve(s) 50, flow of the coolant 40 into coolant branches not associated with the selected battery module(s) to exclusively (to the exclusion of at least the non-selected battery modules) heat the selected battery module(s) via the increased temperature coolant 40. As described above with respect to FIGS. 1-3, exclusive heating of the selected battery module(s) via the increased temperature coolant 40 is intended to enhance cold start discharge power of the RESS 24. A single battery module may be selected in the RESS 24 for such exclusive heating. Following frame 112, method 100 may proceed to frame 114. In frame 114, the method may include demanding or triggering generation of cold start discharge power from the RESS 24, e.g., to operate the powertrain 12.

After frame 114 method 100 may advance to frame 116. In frame 116, the method includes assessing, via the electronic controller 56, whether discharge power of the RESS 24 is at or above the power threshold 72. Following frame 116, method 100 may advance to frame 118. In frame 118, the method includes opening, via the electronic controller 56 using the flow-valve(s) 50, flow of the coolant 40 into each of the coolant branches arranged in parallel (coolant branches 44-1, 44-2, 44-3 associated with the respective battery modules and coolant branches for other devices) in the RESS 24 when the discharge power is at or above the power threshold 72. Opening the flow of coolant 40 into each of the coolant branches 44-1, 44-2, 44-3 is intended to equalize temperatures throughout the corresponding battery modules and other devices of the RESS 24. In frame 118, the method may further include determining, via the electronic controller 56 using the temperature sensors 66-1, 66-2, 66-3, when the temperatures throughout the subject battery modules have been equalized.

Following either frame 112, 114, 116, or 118, the method may loop back to frame 104 for continued monitoring of the RESS 24 and detecting temperature of the RESS for comparing with the temperature threshold 60. If the vehicle 10 continues to demand power discharge from the RESS 24 and the power generation is judged to be unaffected by the combined factors of RESS SOC and low temperature, the method may conclude in frame 120. Alternatively, if the powertrain 12 and other vehicle systems have been switched off, and the fluid pump 42 has been deactivated, the method may shut down current flow and power generation in the RESS 24 and similarly conclude in frame 120.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework and the scope of the appended claims.

What is claimed is:

1. A system for enhancing cold start discharge power of a multi-cell rechargeable energy storage system (RESS) having a plurality of battery cells arranged in individual battery modules connected electrically in parallel, the system comprising:
a cooling subsystem including:
a main coolant loop configured to circulate coolant;
a coolant heater arranged in the main coolant loop;
a plurality of coolant branches arranged in parallel, wherein at least some of the coolant branches are configured to receive respective portions of the coolant from the main coolant loop to adjust temperature of corresponding individual battery modules; and
at least one flow-valve configured to regulate and distribute across the plurality of coolant branches the coolant circulated through the main coolant loop; and
an electronic controller in operative communication with the cooling subsystem and configured to:
detect a temperature of the RESS being at or below a predetermined value;
increase temperature of the coolant, using the coolant heater, in the main coolant loop above the predetermined value;
select at least one battery module, but fewer than all the respective battery modules, in the RESS using predetermined criteria;
identify each coolant branch, from among the plurality of coolant branches, associated with the selected at least one battery module; and
shut off, via the at least one flow-valve, a flow of the coolant into coolant branches not associated with the selected at least one battery module to exclusively heat the selected at least one battery module via the increased temperature coolant and thereby enhance cold start discharge power of the RESS.

2. The system of claim 1, wherein the at least one selected battery module is a single battery module.

3. The system of claim 1, wherein the predetermined criteria include whether cold start discharge power capability of the RESS is determined to be greater with heating the at least one battery module as compared to heating each of the respective battery modules.

4. The system of claim 1, wherein:
the predetermined criteria include battery module state of charge (SOC) and battery module temperature, each associated with discharge power capability of the RESS; and
the subject predetermined criteria are assembled into a look-up table, programmed into the electronic controller, including the battery module SOC and temperature versus the discharge power capability of the RESS over time.

5. The system of claim 1, wherein the predetermined criteria include whether cold start discharge power capability of the RESS is below a power threshold.

6. The system of claim 5, wherein, following the shut off of the flow of the coolant into coolant branches not associated with the selected at least one battery module, the electronic controller is additionally configured to:
assess whether discharge power of the RESS is at or above the power threshold; and
open, via the at least one flow-valve, flow of the coolant into each of the coolant branches arranged in parallel when the discharge power is at or above the power threshold to equalize temperatures throughout the RESS battery modules.

7. The system of claim 6, wherein:
each battery module includes a respective temperature sensor in communication with the electronic controller and configured to detect a temperature of the corresponding battery module; and
the electronic controller is additionally configured to determine, using the temperature sensors, when the temperatures throughout the RESS battery modules have been equalized.

8. The system of claim 1, wherein the at least one flow-valve is a multi-way valve assembly arranged in a junction between the main coolant loop and the plurality of coolant branches and configured to control a flow of the coolant into each of the coolant branches.

9. The system of claim 1, wherein the at least one flow-valve is a plurality of throttle valves, each throttle valve arranged in one of the plurality of coolant branches upstream of the corresponding battery module and configured to control a flow of the coolant into the subject coolant branch.

10. The system of claim 1, wherein each coolant branch includes a one-way valve configured to control a flow of the coolant out of the subject coolant branch.

11. A method of enhancing cold start discharge power of a multi-cell rechargeable energy storage system (RESS) having a plurality of battery cells arranged in individual battery modules connected electrically in parallel, the method comprising:
detecting, via an electronic controller, a request for the RESS cold start discharge power, wherein the electronic controller is in operative communication with a cooling subsystem including:
a main coolant loop configured to circulate coolant;
a coolant heater arranged in the main coolant loop;
a plurality of coolant branches arranged in parallel, wherein at least some of the coolant branches are configured to receive a portion of the coolant from the main coolant loop to adjust temperature of one of the respective battery modules; and
at least one flow-valve configured to regulate and distribute across the plurality of coolant branches the coolant circulated through the main coolant loop;
detecting, via the electronic controller, a temperature of the RESS being at or below a predetermined value;
increasing, via the electronic controller, temperature of the coolant, using the coolant heater, in the main coolant loop above the predetermined value;
selecting, via the electronic controller at least one battery module, but fewer than all the respective battery modules, in the RESS using predetermined criteria;
identifying, via the electronic controller, each coolant branch, from among the plurality of coolant branches, associated with the selected at least one battery module; and
shutting off, via the electronic controller using the at least one flow-valve, a flow of the coolant into coolant branches not associated with the selected at least one battery module to exclusively heat the selected at least one battery module via the increased temperature coolant and thereby enhance cold start discharge power of the RESS.

12. The method of claim 11, wherein selecting the at least one battery module includes selecting a single battery module.

13. The method of claim 11, wherein the predetermined criteria include whether cold start discharge power capability of the RESS is determined to be greater with heating the at least one battery module as compared to heating each of the respective battery modules.

14. The method of claim 11, wherein:
the predetermined criteria include battery module state of charge (SOC) and battery module temperature, each associated with discharge power capability of the RESS; and
the subject predetermined criteria are assembled into a look-up table, programmed into the electronic controller, including the battery module SOC and temperature versus the discharge power capability of the RESS over time.

15. The method of claim 11, wherein the predetermined criteria include whether cold start discharge power capability of the RESS is below a power threshold.

16. The method of claim 15, following the shut off of the flow of the coolant into coolant branches not associated with the selected at least one battery module, further comprising:
assessing, via the electronic controller, whether discharge power of the RESS is at or above the power threshold; and
opening, via the electronic controller using the at least one flow-valve, flow of the coolant into each of the coolant branches arranged in parallel when the discharge power is at or above the power threshold to equalize temperatures throughout the RESS battery modules.

17. The method of claim 16, wherein each battery module includes a respective temperature sensor in communication with the electronic controller and configured to detect a temperature of the corresponding battery module, the method further comprising:
determining, via the electronic controller using the temperature sensors, when the temperatures throughout the RESS battery modules have been equalized.

18. A motor vehicle comprising:
an electric motor-generator configured to generate torque;
a multi-cell rechargeable energy storage system (RESS) configured to supply electrical energy to the electric motor-generator, the RESS including:
a plurality of battery cells arranged in individual battery modules connected electrically in parallel; and
a cooling subsystem including:
a main coolant loop configured to circulate coolant;
a coolant heater arranged in the main coolant loop;
a plurality of coolant branches arranged in parallel, wherein:
at least some of the coolant branches are configured to receive respective portions of the coolant from the main coolant loop to adjust temperature of corresponding individual battery modules; and
each coolant branch includes a one-way valve configured to control a flow of the coolant out of the subject coolant branch; and
at least one flow-valve configured to regulate and distribute across the plurality of coolant branches the coolant circulated through the main coolant loop; and
an electronic controller in operative communication with the cooling subsystem and configured to:
detect a request for the RESS cold start discharge power;
detect a temperature of the RESS being at or below a predetermined value;
increase temperature of the coolant, using the coolant heater, in the main coolant loop above the predetermined value;
select at least one battery module, but fewer than all the respective battery modules, in the RESS using predetermined criteria, wherein the predetermined criteria include whether cold start discharge power capability of the RESS is determined to be greater with heating the at least one battery module as compared to heating each of the respective battery modules;
identify each coolant branch, from among the plurality of coolant branches, associated with the selected at least one battery module; and
shut off, via the at least one flow-valve, a flow of the coolant into coolant branches not associated with the selected at least one battery module to exclusively heat the selected at least one battery module via the increased temperature coolant and thereby enhance cold start discharge power of the RESS.

19. The motor vehicle of claim 18, wherein:
the predetermined criteria include battery module state of charge (SOC) and battery module temperature, each associated with discharge power capability of the RESS; and
the subject predetermined criteria are assembled into a look-up table, programmed into the electronic controller, including the battery module SOC and temperature versus the discharge power capability of the RESS over time.

20. The motor vehicle of claim 18, wherein the predetermined criteria include whether cold start discharge power capability of the RESS is below a power threshold, and wherein, following the shut off of the flow of the coolant into coolant branches not associated with the selected at least one battery module, the electronic controller is additionally configured to:
assess whether discharge power of the RESS is at or above the power threshold; and
open, via the at least one flow-valve, flow of the coolant into each of the coolant branches arranged in parallel when the discharge power is at or above the power threshold to equalize temperatures throughout the RESS battery modules.
